(19) United States
(12) Patent Application Publication
(10) Pub. No.: US 2018/0178400 A1
(43) Pub. Date: Jun. 28, 2018

(54) BEARD TRIMMER COMPRISING ONE OR MORE ROTATING HEADS HAVING A CLEANING ARRANGEMENT

(71) Applicant: BaByliss Faco sprl, Wandre (BE)

(72) Inventors: Olivier SMAL, Magnee (BE); Pierre JULEMONT, Soumagne (BE)

(73) Assignee: BaByliss Faco sprl, Wandre (BE)

(21) Appl. No.: 15/579,379

(22) PCT Filed: May 27, 2016
(86) PCT No.: PCT/EP2016/062053

§ 371 Date: Dec. 4, 2017

(30) Foreign Application Priority Data
Jun. 8, 2015 (EP) 15170951.6

(51) Int. Cl. B26B 19/20; B26B 19/14; A45D 27/46

(52) U.S. Cl. CPC B26B 19/20; A45D 27/46; B26B 19/146

(57) ABSTRACT

The present invention relates to a beard trimmer comprising a handle (18) and a casing (5) as well as a cutting system comprising one or more rotating cutting heads (1), said rotating heads comprising a movable blade (2) and a stationary blade (3), each head being surrounded by a crown-shaped comb (4), said comb being height adjustable and making it possible, during use, to adjust the distance between said blades and the skin and thus to cut the beard hairs to the desired length. The invention is characterized in that said casing is movably mounted on said handle, making it possible to create a gap (6) between the casing and the handle in order to rinse the cutting system.

### FIELD OF THE INVENTION

The present invention relates to a beard trimmer comprising at least one, preferably two or three rotary cutting heads with a vertical axis. The cutting mechanism of these rotary heads is equipped with a moving blade and a fixed blade. Each cutting head is surrounded by crown-shaped combs, the height of which is adjustable. The height by which the comb teeth protrude relative to the fixed blade makes it possible to adjust the distance between the cutting mechanism and the skin, and thus to adjust the cutting length of the beard. Inasmuch as this manner of trimming beards quickly generates a large quantity of hairs that may become lodged in the cavities of the cutting system of the trimmer, the latter is equipped with a mechanism making it possible to create a space between the handle and the cover that allows rinsing with water from the inside toward the outside and from the outside toward the inside. The invention also relates to a cleaning kit for such a trimmer.

### BACKGROUND OF THE INVENTION

The beard trimmers of the state of the art have linear moving and fixed blades, the operation of which is based on a to-and-fro movement of the moving blade relative to the fixed blade. This type of trimmer is generally equipped with a comb that allows it to adjust the cutting length of the beard. Such beard trimmers are for example disclosed in US D 698,084, U.S. Pat. No. 6,978,547, US D 486,267, EP 2 766 153 A1, US D 363,809, US 2013/0042487, U.S. Pat. No. 7,076,878, US D 521,683, etc.

Of course, razors with multiple rotary heads exist that make it possible to achieve a very close shave, but which cannot be used to trim a beard. Razors with rotary heads do not have combs to adjust the distance between the cutting mechanism and the skin. To the best of our knowledge, no beard trimmer with vertical axis rotary heads exists in the state of the art.

The trimmers of the state of the art have a straight cutting line at the intersection of the moving teeth and the fixed teeth. They have the drawback of trimming the hairs differently depending on the trimming direction, since the beard hairs are most often inclined in a direction, they almost never grow perpendicular to the skin. The result of trimming with these trimmers is thus different depending on the movement direction over the beard to be trimmed.

Inasmuch as this type of trimmer is not known in the state of the art, one skilled in the art has never been faced with the issue of cleaning a trimmer with vertical axis rotary heads. These trimmers generate a very significant quantity of cut hairs near the cutting system. They must therefore be rinsed with water after each time a beard is trimmed.

### AIMS OF THE INVENTION

The present invention aims to provide a beard trimmer with one or several rotary heads surrounded by crown-shaped combs and with an adjustable length making it possible to adjust the cutting height of the beard, the trimmer being equipped with several functionalities making it easier to clean, as well as a cleaning kit.

### SUMMARY OF THE INVENTION

The present invention discloses a beard trimmer comprising a handle and a cover as well as a cutting system with one or several rotary cutting heads, said rotary cutting heads comprising a moving blade and a fixed blade, each head being surrounded by a crown-shaped comb, said comb being height adjustable and making it possible to adjust, in use, the distance between said blades and the skin, and thus to adapt the cutting of the beard hairs to the desired length, characterized in that said cover is movably mounted between an open position and a closed position on said handle making it possible to create a space between the cover and said handle to rinse the cutting system.

The preferred embodiments of the invention comprise at least one, or any appropriate combination, of the following features:
the space is created by actuating a means for moving the cover away;
the cover is translated along the direction of the shaft to create the space between the cover and said handle;
the means for moving the cover away releases the latter from its anchoring so as to create the translational movement by a spring located around the shaft to create the space between the cover and said handle;
the cover is moved away in a motorized manner;
the trimmer comprises backup unlocking making the cover completely removable;
the rotation axis of the moving blade comprises a cylinder with fins making it possible, during rinsing, to intensify the flow of liquid through the cutting system of said trimmer;
the height adjustment of the combs is motorized and may be positioned to within half a millimeter;
the comb allows the adjustment of a distance between the cutting mechanism and
the skin comprised between 0 and 20 mm, preferably between 1 and 15 mm, and particularly preferably between 2 and 12 mm with a precision of 0.5 mm.

The present invention also discloses a cleaning kit for the beard trimmer according to the invention, comprising a base with a reservoir for a cleaning liquid and able to receive and fasten said trimmer.

The kit may further comprise a mixing helix in the reservoir and an ultrasound generator. It may also comprise a battery charger for the trimmer according to the invention.

### BRIEF DESCRIPTION OF THE FIGURES

FIG. 1 shows a beard trimmer according to the invention comprising three vertical axis rotary heads. The crown-shaped comb around the rotary heads is shown with three different adjustment heights. These three adjustments for example make it possible to obtain beard hair lengths of 2, 6 and 10 mm. It is, however, possible to vary the cutting height by modifying the position of the fixed and moving blades relative to a fixed-height comb (not shown). This configuration would, however, be much more difficult to implement mechanically.

FIG. 2 shows embodiments of the trimmer according to the invention with one and two rotary cutting heads.

FIG. 3 schematically shows the mechanism for adjusting the height of the combs relative to the plane formed by the cutting system (fixed and moving blades).

FIG. 4 shows a detailed view of the adjustment of the cutting height and the cutting mechanism and how it is able to trim the beard hairs to the desired height.

FIG. 5 shows the opening functionality of the trimmer according to the invention. The latter is accessible via a push button on the handle and makes it possible to open the device to rinse it under a faucet. The rinsing is shown in two different positions where the stream of water flows from the inside toward the outside (approximately horizontal position) and from the outside toward the inside (approximately vertical position).

FIG. 6 shows the cleaning position, which shows a cylinder with helical fins making it possible to intensify the flow of water through the cutting system during cleaning.

FIG. 7 shows a sectional view of the closed trimmer showing the detail of the mechanism making it possible to open the trimmer by moving the cover away from the handle. The thick black arrows indicate the future movement of the comb when the cover is released from its anchoring, which is indicated by the small transparent arrows.

FIG. 8 shows a sectional view of the trimmer in the open position with the cover released from its anchoring and moved away from the handle by about 20 mm.

FIG. 9 shows a detailed view of the components found on the vertical axis of the cutting system with the fixed and moving blades and a cylinder with fins positioned on the rotation axis of the moving knives making it possible to intensify the flow of water through the cutting system during cleaning. Two types of cylinders with helical and radial fins are also shown in detail with their rotation direction.

FIG. 10 shows a kit that may be associated with the trimmer according to the invention to facilitate cleaning thereof. The kit comprises a base and a reservoir equipped with a helix making it possible to intensify the flow of water through the cutting system during cleaning.

FIG. 11 shows a sectional view of the cleaning kit.

FIG. 12 describes the operation of the cleaning cycle with its various steps.

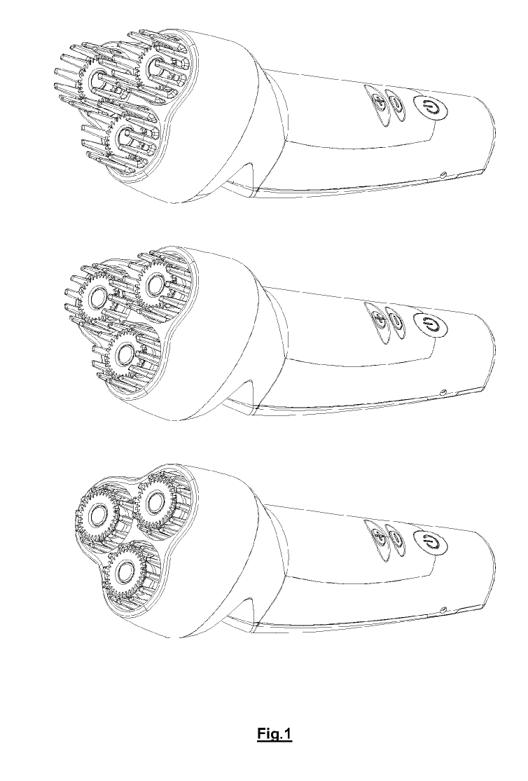

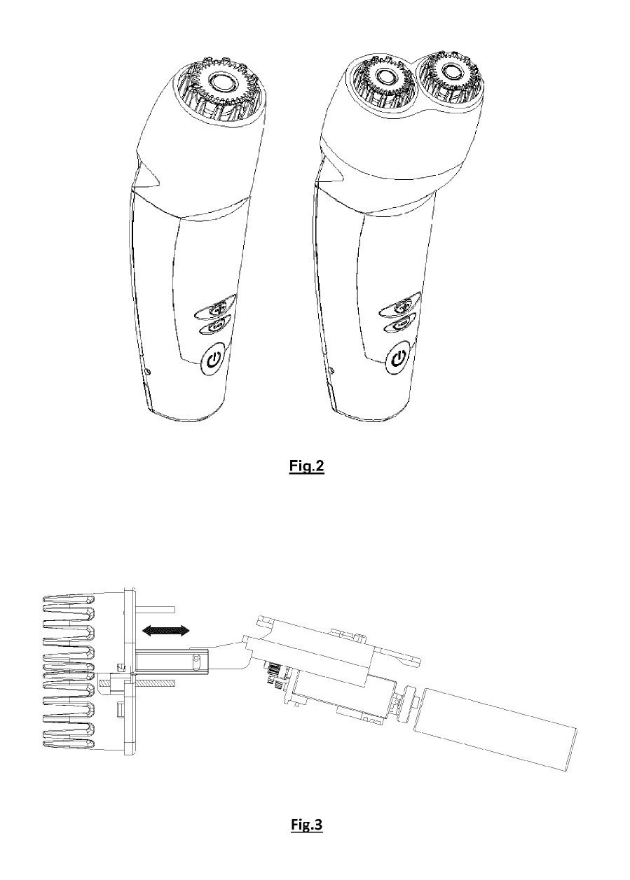

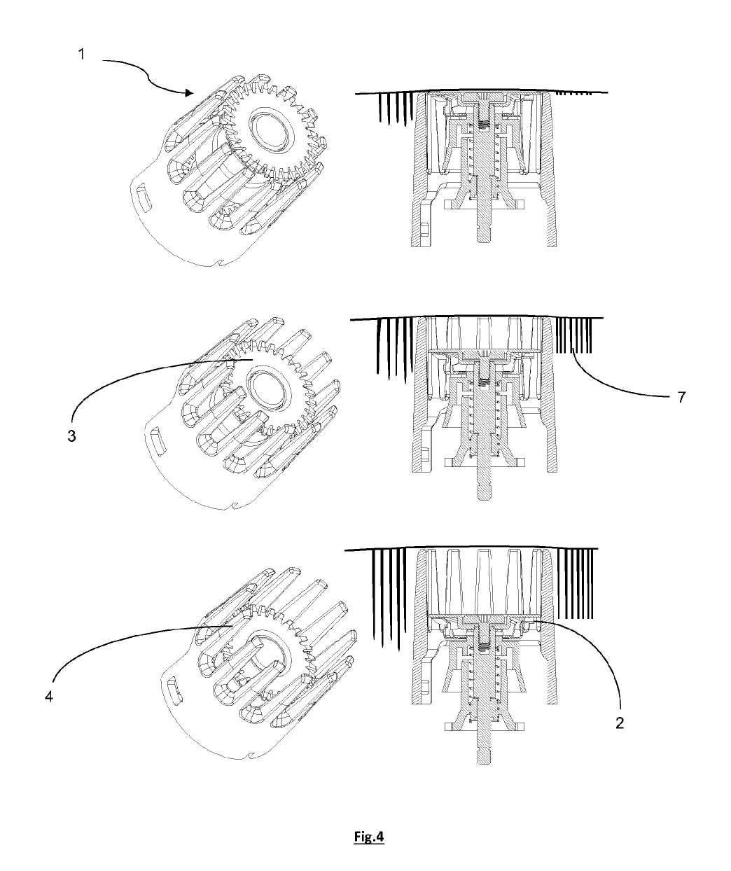

### LIST OF REFERENCE SYMBOLS

1. Circular rotary head with a vertical axis

2. Moving blade

3. Fixed blade

4. Crown-shaped comb surrounding the cutting head

5. Cover

6. Open position for cleaning the device

7. Beard hairs

8. Push button to open the device for rinsing

9. Cylinder with helical or radial fins

10. Anchoring of the cover

11. Shaft with a spring to raise the cover once released from its anchoring

12. Arm making it possible to move the comb and vary the cutting height

13. Cleaning kit for the trimmer according to the invention

14. Cleaning liquid reservoir

15. Helix of the cleaning kit reservoir

16. Bearing part

17. Backup unlocking

18. Handle

19. Connection means

### DETAILED DESCRIPTION OF THE INVENTION

Unlike the beard trimmers of the state of the art, the trimmer according to the present invention has one or several vertical axis circular rotary heads 1, surrounded by crown-shaped combs 4, the height of which can be adjusted to within half a millimeter relative to the fixed blade. This adjustment can be manual or motorized (not shown). This trimmer allows a movement in arcs of circle over the beard, just like a rotary head razor. This type of movement has the advantage of beginning to trim the beard hairs from all sides, irrespective of the incline thereof relative to the skin, which results in uniform trimming of the beard.

The movement of the combs 4 raises the hair, which ultimately penetrate from the outside of the combs toward the cutting system made up of a fixed blade 3 and a moving blade 2 via the space left between the teeth in the trimming zone. The particular shape of the teeth of the comb 4, which become gradually finer toward the tip, allows easy penetration of the beard hairs toward the cutting system.

The fixed blade 3 comprises radial notches, which also favors the penetration of the hairs in the cutting mechanism.

The height of the telescoping combs 4 can be adjusted approximately between 0 and 20 mm, preferably between 0 and 15 mm, and particularly preferably between 0 and 12 mm. The combs are therefore almost completely retractable in the cover 5 to take up less space when storing the trimmer.

The cleaning function of the trimmer according to the invention is very important inasmuch as a beard trim, which is often done only once or twice per week, generates significantly more cutting waste than simple shaving.

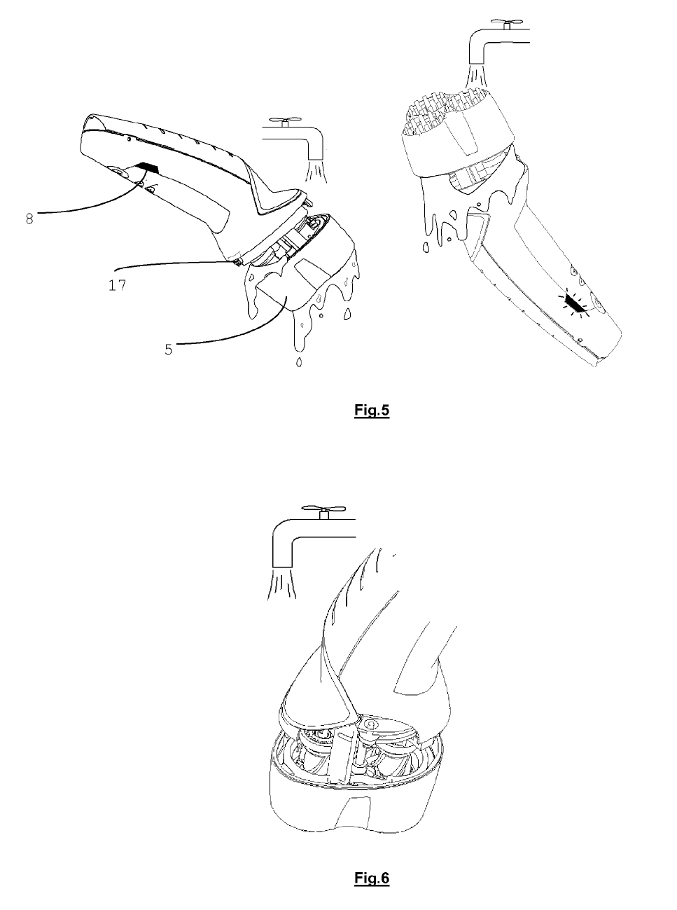

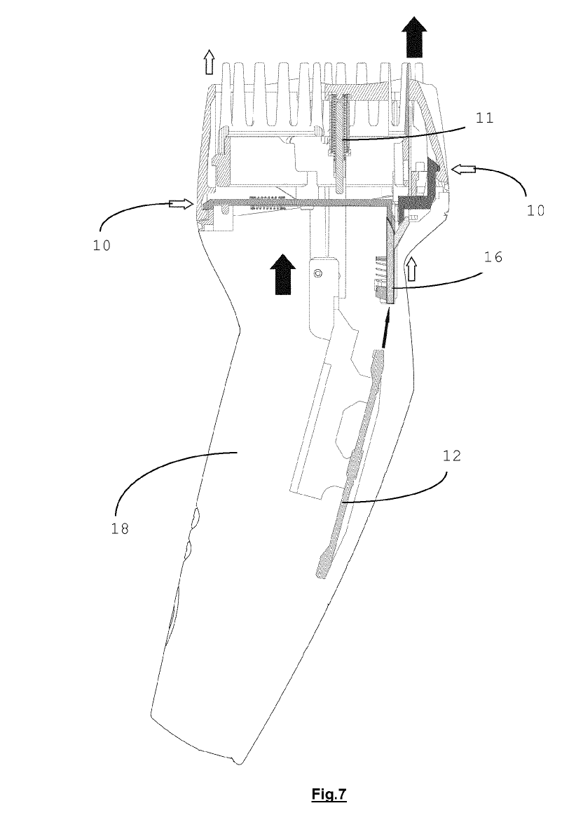

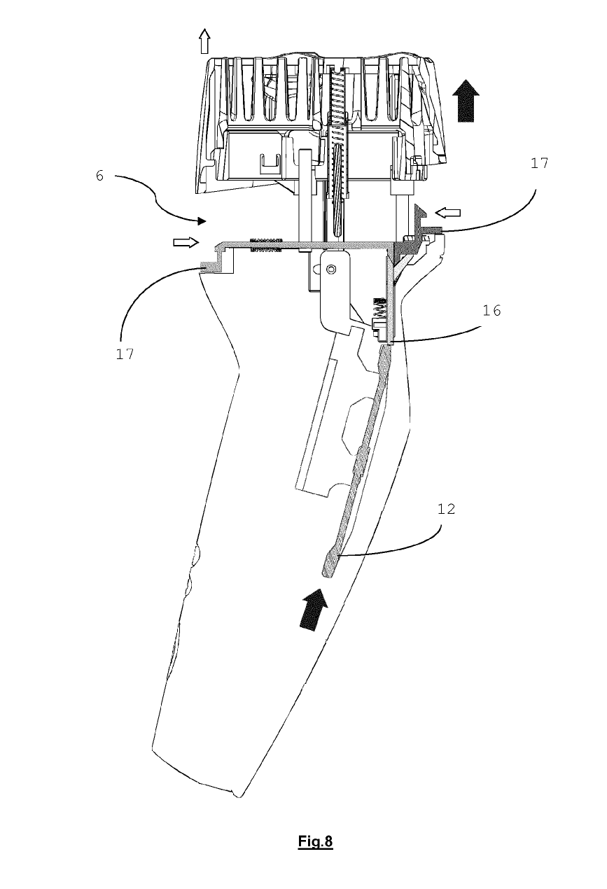

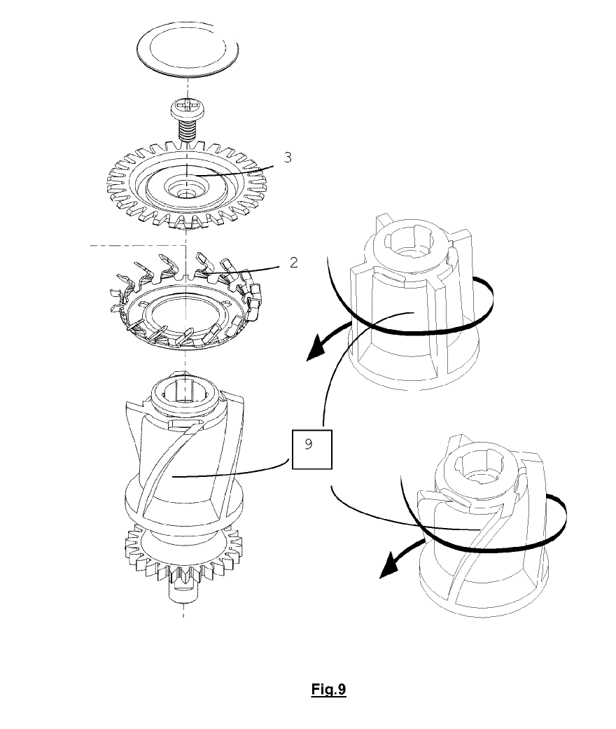

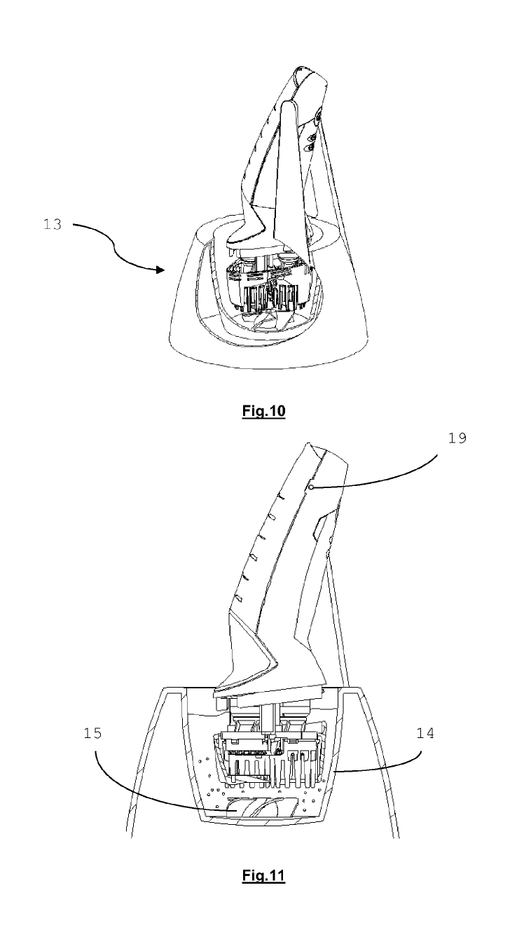

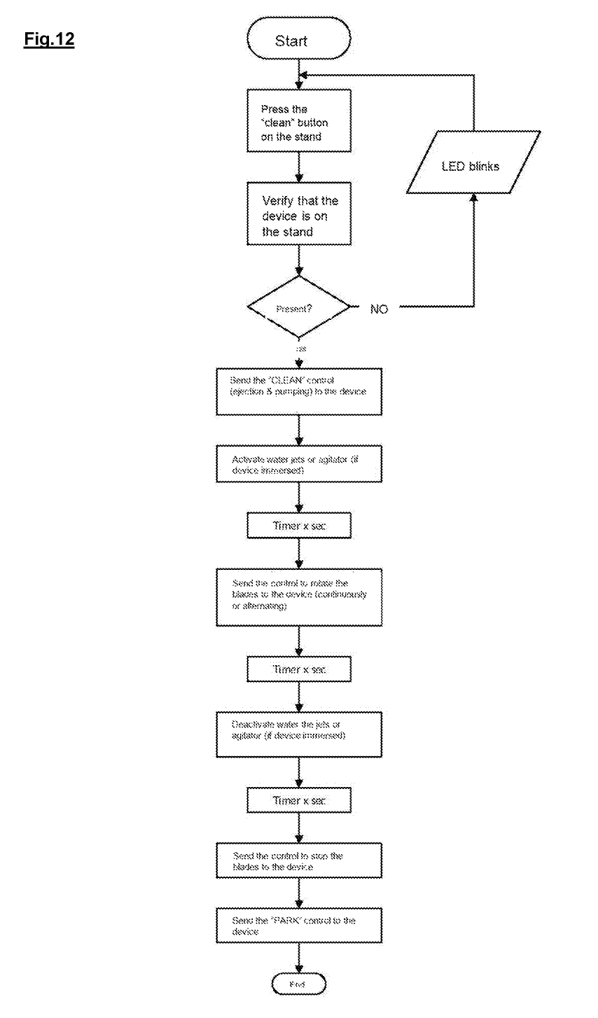

The present invention therefore proposes a series of solutions making it possible to facilitate and improve cleaning of the device, which include, among other things:
an opening functionality of the trimmer making it possible to detach the cover 5 from the handle 18 and to open the device while keeping the cover 5 fastened thereon. The opening thus allows rinsing with water by passing water from the inside toward the outside or from the outside toward the inside (see FIGS. 5 and 6);
a cylinder 9 with radial or helical fins is fastened on the rotation axis of the moving blade and makes it possible to generate a more intense flow of water through the cutting mechanism (see FIG. 7);
a cleaning kit 13 comprising a base and a reservoir 14 suitable for receiving the trimmer according to the invention. In use, the trimmer is immersed in a cleaning liquid that may be set in motion by a helix 15.

The mechanism making it possible to open the trimmer according to the invention is shown in FIGS. 7 (closed position) and 8 (open position).

First, a manual or motorized arm 12 pushes the comb via a bearing part 16 to release the anchoring 10 and push the combs toward a maximum height position. The cover is next pushed upward via a spring surrounding a central shaft 11.

After rinsing with water, the cover 5 is pushed back into its starting position and the trimmer is closed.

The trimmer also comprises two backup push buttons 17 making it possible to remove the entire cover if the opening mechanism seizes up due to an excessive quantity of cut hairs in the cutting system.

After several hours of use, simple rinsing with water may no longer be sufficient to clean the trimmer. This is why a cleaning kit is provided for in-depth cleaning of the device. This cleaning kit comprises a reservoir with a detergent solution provided for the trimmer. It may also comprise a helix intended to stir the solution and/or an ultrasound generator. The trimmer according to the invention can be submerged therein after the cover 5 has been completely removed from the device. Lastly, the cleaning kit can also, in addition to the cleaning and ultrasound functions, comprise a charging function for the battery of the trimmer according to the invention. The cleaning kit can thus combine the charging and ultrasonic bath functions. The connecting means 19 between the trimmer and the cleaning kit make it possible to provide the pulses necessary for the cleaning cycle shown in FIG. 12.

1. A beard trimmer comprising a handle and a cover as well as a cutting system with one or several rotary cutting heads, said rotary cutting heads comprising a moving blade and a fixed blade, each head being surrounded by a crown-shaped comb, said comb being height adjustable and making it possible to adjust, in use, the distance between said blades and the skin, and thus to adapt the cutting of the beard hairs to the desired length, wherein said cover is movably mounted between an open position and a closed position on said handle making it possible to create a space between the cover and said handle to rinse the cutting system.

2. The beard trimmer according to claim 1, wherein the space is created by actuating a means for moving the cover away.

3. The beard trimmer according to claim 1, wherein the cover is translated along the direction of a shaft to create the space between the cover and said handle.

4. The beard trimmer according to claim 1, wherein the means for moving the cover away releases the latter from its anchoring so as to create the translational movement by a spring located around a shaft to create the space between the cover and said handle.

5. The beard trimmer according to claim 1, wherein the cover is moved away in a motorized manner.

6. The beard trimmer according to claim 1, wherein said trimmer comprises a backup unlocking making the cover completely removable.

7. The beard trimmer according to claim 1, wherein the rotation axis of the moving blade comprises a cylinder with fins making it possible, during rinsing, to intensify the flow of liquid through the cutting system of said trimmer.

8. The beard trimmer according to claim 1, wherein the height adjustment of the combs is motorized and may be positioned to within half a millimeter.

9. The beard trimmer according to claim 1, wherein said comb allows the adjustment of a distance between the cutting mechanism and the skin comprised between 0 and 20 mm, preferably between 1 and 15 mm, and particularly preferably between 2 and 12 mm with a precision of 0.5 mm.

10. A cleaning kit for the beard trimmer according to claim 1, comprising a base with a reservoir for a cleaning liquid and able to receive and fasten said trimmer, the depth of the bath being suitable for being able to submerge the trimmer in the open position.

11. The kit according to claim 10, comprising a mixing helix in the reservoir.

12. The kit according to claim 10, comprising an ultrasound generator.

13. (canceled)

14. The kit according to claim 10, comprising a battery charger for the trimmer of claim 1.
